(19) United States
(12) Patent Application Publication
(10) Pub. No.: US 2011/0225974 A1
(43) Pub. Date: Sep. 22, 2011

(54) Multiple Zone Pilot For Low Emission Combustion System

(75) Inventors: Abdul Rafey Khan, Greenville, SC (US); Thomas Edward Johnson, Greer, SC (US)

(73) Assignee: GENERAL ELECTRIC COMPANY, Schenectady, NY (US)

(21) Appl. No.: 12/728,704

(22) Filed: Mar. 22, 2010

(51) Int. Cl. F02C 7/22

(52) U.S. Cl. 60/746; 60/748

(57) ABSTRACT

A method of operating a combustor includes delivering a primary fuel flow through a plurality of primary fuel nozzles toward a primary combustion zone and combusting the primary fuel flow in the primary combustion zone. A secondary fuel flow is delivered through a secondary fuel nozzle toward a secondary combustion zone and combusted therein. The secondary fuel is located such that the plurality of primary fuel nozzles are arrayed around the secondary fuel nozzle. An outer swirler is located between the plurality of primary fuel nozzles and the secondary fuel nozzle and includes a plurality of outer swirler channels extending therethrough. A flow of swirler fuel is delivered through the plurality of outer swirler channels into the combustor substantially between the primary combustion zone and the secondary combustion zone to stabilize combustion in the primary combustion zone and/or the secondary combustion zone.

### BACKGROUND OF THE INVENTION

The subject matter disclosed herein generally relates to turbomachines. More specifically, the subject disclosure relates to fuel and air passages through fuel nozzles for turbomachines.

As requirements for gas turbine emissions have become more stringent, one approach to meeting such requirements is to move from diffusion flame combustors to combustors utilizing lean fuel and air mixtures using a fully premixed operation mode to reduce emissions of, for example, NOₓ and CO. These combustors are known in the art as Dry Low NOₓ (DLN), Dry Low Emissions (DLE) or Lean Pre Mixed (LPM) combustion systems. These combustors typically include a plurality of primary nozzles which are ignited for low load and mid load operations of the combustor in a primary combustion zone. During fully premixed operations, the primary nozzles supply fuel to feed the secondary flame. The primary nozzles typically surround a secondary nozzle that is utilized for mid load up to fully premixed mode operations of the combustor, feeding a secondary combustion zone. An outer swirler is typically located surrounding the secondary nozzle between the primary and secondary combustion zones. The outer swirler includes a plurality of swirler passages through which air is injected into the secondary combustion zone. The swirler air creates a zone of lower fuel-to-air ratio between the primary and secondary combustion zones, and acts to quench the primary and secondary flames. This quenching results in combustion instabilities, higher emissions and lower turndown margins.

### BRIEF DESCRIPTION OF THE INVENTION

According to one aspect of the invention, a combustor for a turbomachine includes a plurality of primary fuel nozzles located in a combustor liner and a secondary fuel nozzle located in the combustor liner such that the plurality of primary fuel nozzles are arrayed about the secondary fuel nozzle. An outer swirler is positioned circumferentially around the secondary fuel nozzle between the secondary fuel nozzle and the plurality of primary fuel nozzles and includes a plurality of outer swirler channels for delivering fuel and/or air into an interior of the combustor.

According to another aspect of the invention, a method of operating a combustor includes delivering a primary fuel flow through a plurality of primary fuel nozzles toward a primary combustion zone and combusting the primary fuel flow in one or more of the primary combustion zone or a secondary combustion zone. A secondary fuel flow is delivered through a secondary fuel nozzle toward the secondary combustion zone and combusted therein. The secondary fuel nozzle is located such that the plurality of primary fuel nozzles are arrayed around the secondary fuel nozzle. An outer swirler is located between the plurality of primary fuel nozzles and the secondary fuel nozzle and includes a plurality of outer swirler channels extending therethrough. A flow of swirler fuel and/or air is delivered through the plurality of outer swirler channels into the combustor substantially between the primary combustion zone and the secondary combustion zone to stabilize combustion in the primary combustion zone and/or the secondary combustion zone.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a partial cross-sectional view of an embodiment of a turbomachine;

FIG. 2 is a cross-sectional view of an embodiment of a combustor of a turbomachine;

FIG. 3 is an end view of a nozzle arrangement of an embodiment of a combustor; and

FIG. 4a-4d are schematic views of operational modes of an embodiment of a combustor.

The detailed description explains embodiments of the invention, together with advantages and features, by way of example with reference to the drawings.

### DETAILED DESCRIPTION OF THE INVENTION

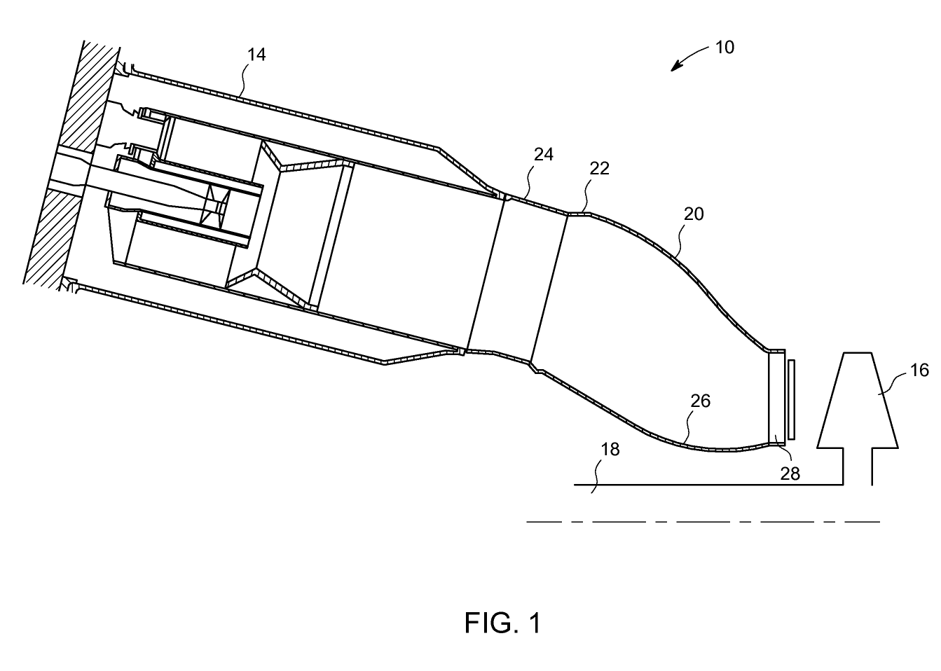

Shown in FIG. 1 is a turbomachine, for example, a gas turbine 10. The gas turbine 10 includes a plurality of combustors 14. Fuel is injected into the combustors 14, mixes and is ignited. The hot gas product of the combustion flows to a turbine 16 which extracts work from the hot gas to drive a rotor shaft 18. The plurality of combustors 14 may be arranged circumferentially around the rotor shaft 18, and in some embodiments may number 10 or 14 combustors 14. A transition piece 20 is coupled at an upstream end 22 to the combustor 14 at a combustor liner 24 and at a downstream end 26 to an aft frame 28 of the turbine 16. The transition piece 20 carries hot gas flow from the combustor liner 24 to the turbine 16.

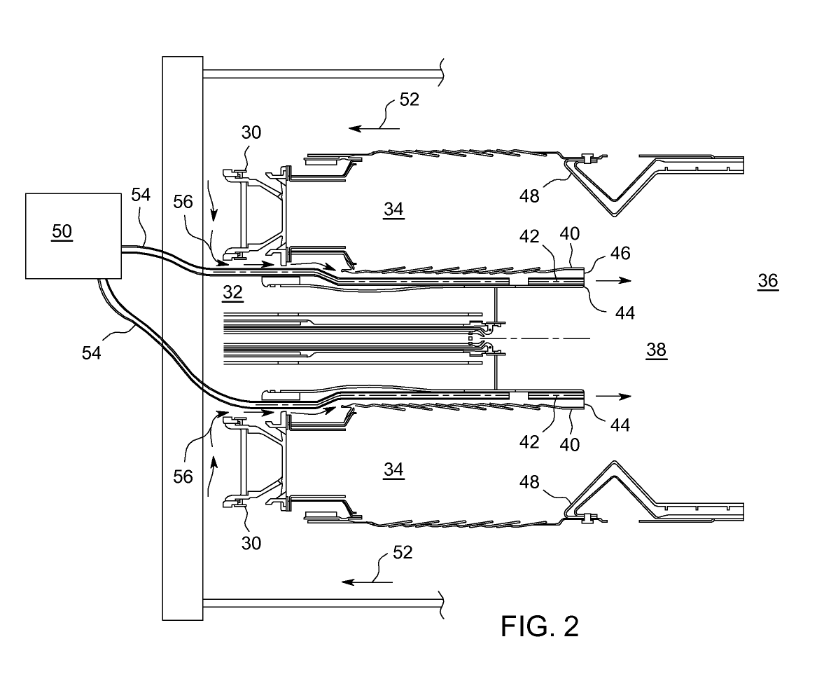

Shown in FIG. 2 is a cross-sectional view of the combustor 14 of, for example, the gas turbine 10. The combustor 14 includes a plurality of primary fuel nozzles 30 arrayed around a secondary fuel nozzle 32. In some embodiments, the plurality of primary fuel nozzles 30 are arranged in a circular pattern with the secondary fuel nozzle 32 located at a center of the circle. The plurality of primary fuel nozzles 30 supply fuel and air to primary combustion zone 34 in a combustion chamber 36 while the secondary fuel nozzle 32 supplies fuel and air to a secondary combustion zone 38 in the combustion chamber 36.

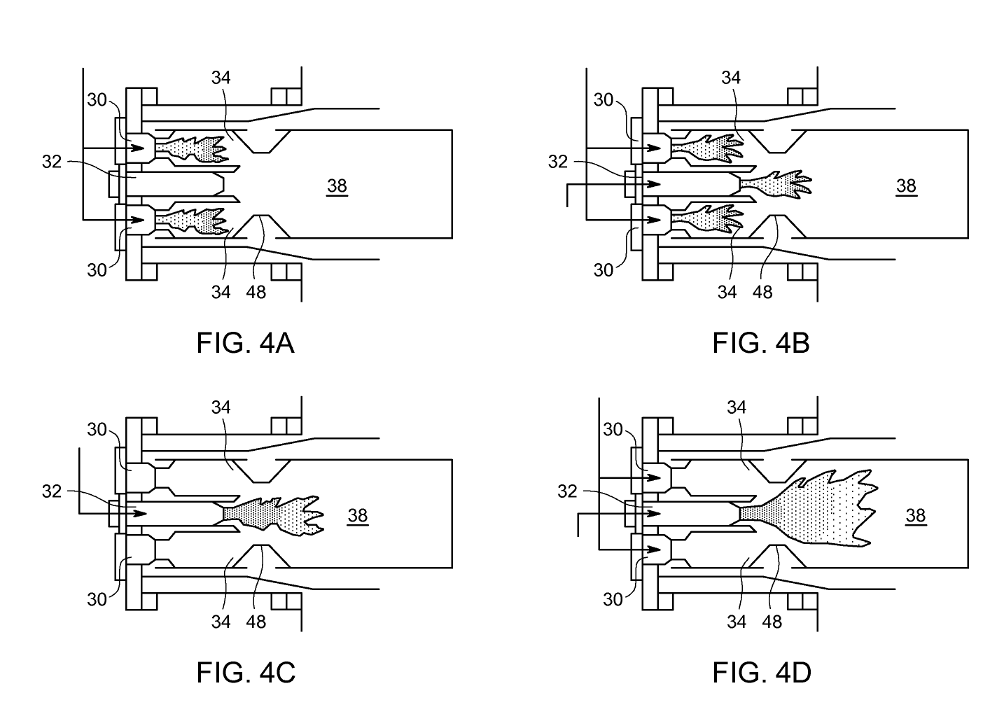

Referring to FIGS. 4a-4d, the primary fuel nozzles 30 and the secondary fuel nozzle 32 are utilized differently for different operating conditions of the combustor 14. As shown in FIG. 4a, when the combustor 14 is operating in primary mode, during ignition and low load operations, only the primary fuel nozzles 30 are fueled and ignited, with all combustion occurring in the primary combustion zone 34. In lean mode, shown in FIG. 4b, which is utilized for low to mid load of the combustor 14, the plurality of primary fuel nozzles 30 are fueled and ignited for operation in the primary combustion zone 34. The secondary fuel nozzle 32 is also fueled and ignited, for operation in the secondary combustion zone 38. When the combustor 14 is operating in transfer mode, as shown in FIG. 4c, only the secondary fuel nozzle 32 is fueled and ignited. In fully premixed mode, as shown in FIG. 4d, the secondary fuel nozzle 32 is fueled and ignited for combustion in the secondary combustion zone 38. Fuel is also supplied to the secondary combustion zone 38 through the plurality of primary fuel nozzles 30.

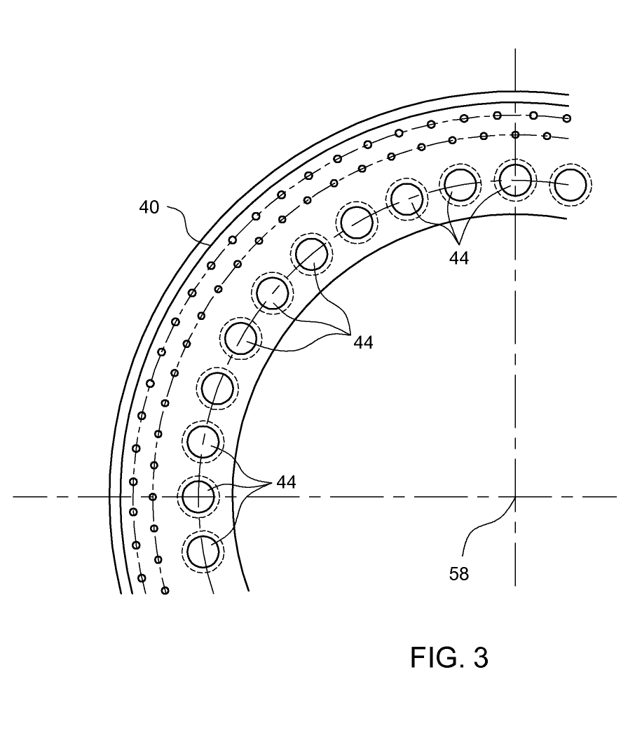

Surrounding the secondary fuel nozzle 32 is an outer swirler 40. Referring again to FIG. 2, the outer swirler 40 includes a plurality of swirler channels 42, which in some embodiments extend substantially axially. As shown in FIG. 3, each swirler channel 42 terminates in a swirler hole 44 of a plurality of swirler holes 44 at, for example, a downstream end 46 of the outer swirler 40. Referring again to FIG. 2, in some embodiments, the plurality of swirler holes 44 are located upstream of a venturi 48 of the combustor 14. In other embodiments, however, the plurality of swirler holes 44 may be located downstream of the venturi 48.

The plurality of swirler channels 42 are connected to a fuel source 50, and in some embodiments, a passively fed air source 52. During operation of the combustor 14, a flow of swirler fuel 54 and a flow of air 56 is flowed from the fuel source 50 and the air source 52 and premixed in the plurality of swirler channels 42 before it is injected into the combustion chamber 36. In some embodiments, the flow of swirler fuel 54 and the flow of air 56 are injected in a directly axial direction into the combustion chamber 36, while in other embodiments, the plurality of swirler channels 42 are configured, for example, helically, such that the flow of swirler fuel 54 and the flow of air 56 are injected at an angle non-parallel to a combustor axis 58.

In effect, the flow of swirler fuel 54 and the flow of air 56 injected into the combustion chamber 36 via the plurality of swirler holes 44 acts as a premixed pilot to stabilize combustion in both the primary combustion zone 34 and the secondary combustion zone 38. For example, when the combustor 14 is operating in lean mode, there are combustion flames in both the primary combustion zone 34 and the secondary combustion zone 38. The presence of the flow of swirler fuel 54 and flow of air 56 injected into the combustion chamber 36 between the primary combustion zone 34 and the secondary combustion zone 38 increases the uniformity of fuel/air ratios between the primary combustion zone 34 and the secondary combustion zone 38, thus enhancing stability in both combustion zones 34/38.

To increase flexibility of the combustor 14, the flow of swirler fuel 54 may be linked to the a primary flow of fuel to the plurality of primary fuel nozzles 30 such that whenever fuel is supplied to the plurality of primary fuel nozzles 30, fuel is also supplied to the plurality of swirler channels 42. In some embodiments, the flow of swirler fuel 54 may be alternatively linked to a secondary flow of fuel to the secondary fuel nozzle 32 such that when fuel is supplied to the secondary fuel nozzle 32, fuel is also supplied to the plurality of swirler channels 42. Alternatively, the supply of fuel to the plurality of swirler channels 42 may be linked to a pilot circuit, independent of the primary fuel flow and the secondary fuel flow.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A combustor for a turbomachine comprising:
a plurality of primary fuel nozzles disposed in a combustor liner;
a secondary fuel nozzle disposed in the combustor liner such that the plurality of primary fuel nozzles are arrayed about the secondary fuel nozzle; and
an outer swirler disposed circumferentially around the secondary fuel nozzle between the secondary fuel nozzle and the plurality of primary fuel nozzles, the outer swirler including a plurality of outer swirler channels for delivering fuel into an interior of the combustor.

2. The combustor of claim 1 wherein the plurality of outer swirler channels are configured to deliver fuel to the interior of the combustor between a primary combustion zone and a secondary combustion zone.

3. The combustor of claim 1 wherein a premixed fuel/air mixture is deliverable through the plurality of outer swirler channels.

4. The combustor of claim 1 wherein a flow of fuel through the plurality of outer swirler channels is linked to a primary fuel flow through the plurality of primary fuel nozzles.

5. The combustor of claim 1 wherein a flow of fuel through the plurality of outer swirler channels is linked to a secondary fuel flow through the secondary fuel nozzle.

6. The combustor of claim 1 wherein fuel enters the interior of the combustor from the plurality of outer swirler channels at a location upstream of a venturi of the combustor.

7. The combustor of claim 1 wherein the plurality of outer swirler channels extend in a direction substantially parallel to a combustor axis.

8. The combustor of claim 7 wherein fuel is delivered from the plurality of outer swirler channels into the interior of the combustor in the direction substantially parallel to the combustor axis.

9. The combustor of claim 1 wherein the plurality of outer swirler channels extend substantially helically around the secondary fuel nozzle.

10. The combustor of claim 9 wherein fuel is delivered from the plurality of outer swirler channels into the interior of the combustor in a direction substantially non-parallel to a combustor axis.

11. A method of operating a combustor comprising:
delivering a primary fuel flow through a plurality of primary fuel nozzles toward a primary combustion zone;
combusting the primary fuel flow in one or more of the primary combustion zone or a secondary combustion zone;
delivering a secondary fuel flow through a secondary fuel nozzle toward the secondary combustion zone, the secondary fuel nozzle disposed such that the plurality of primary fuel nozzles are arrayed around the secondary fuel nozzle;
combusting the secondary fuel flow in the secondary combustion zone;
locating an outer swirler between the plurality of primary fuel nozzles and the secondary fuel nozzle, the outer swirler including a plurality of outer swirler channels extending therethrough; and
delivering a flow of swirler fuel through the plurality of outer swirler channels into the combustor substantially between the primary combustion zone and the secondary combustion zone to stabilize combustion in the primary combustion zone and/or the secondary combustion zone.

12. The method of claim 11 further comprising delivering the flow of swirler fuel into the combustor upstream of a venturi of the combustor.

13. The method of claim 11 wherein flow of swirler fuel is linked to the primary fuel flow.

14. The method of claim 11 wherein flow of swirler fuel is linked to the secondary fuel flow.

15. The method of claim 11 wherein delivering the flow of swirler fuel into the combustor increases a uniformity of fuel-to-air ratios between the primary combustion zone and the secondary combustion zone.

16. The method of claim 11 wherein a premix of fuel and air is delivered through the plurality of outer swirler channels into the combustor.
